(19) United States
(12) Patent Application Publication
(10) Pub. No.: US 2005/0027695 A1
(43) Pub. Date: Feb. 3, 2005

(54) Identifying files suitable for attaching to a text message

(76) Inventors: Peter Thomas John, Como, WA (US); Ying Catherine Cheng, St-Lambert (CA); Philip Olurotimi Ogunbona, Wollongang (AU)

Correspondence Address: DANIEL K. NICHOLS;Motorola, Inc., Law Department, 1303 E. Algonquin Road, Schaumburg, IL, 60196, US

(21) Appl. No.: 10/631,039

(22) Filed: Jul. 29, 2003

(51) Int. Cl. G06F 17/30

(52) U.S. Cl. 707/3

(57) ABSTRACT

The invention provides for a device (1) and method (20) for identifying, from a plurality of files, at least one file suitable for attaching to a text message to be transmitted from the device. The message is typically an EMS or MMS message and the invention includes identifying (22) at least one keyword or phrase in the message to be used in a metadata search. Then the invention conducts searching (23) a least one database for files identified by metadata corresponding to at least one search word associated with the keyword or phrase. Identifying (24) the least one file suitable for attaching to the message is performed, wherein the at least one file has associated metadata matching the search word. A user then may select the file plus other files that are attached to (27) and transmitted (28) with the text message.

### FIELD OF THE INVENTION

This invention relates to automatically identifying possible files that may be suitable for inclusion or attaching to a text message. The invention is particularly useful for, but not necessarily limited to, identifying such possible files based on text in the message.

### BACKGROUND OF THE INVENTION

Sending text to radio telephones by Short Message Service (SMS) messages is becoming common practice and allows messages to be sent without first having to establish a telecommunications connection between two network subscribers. Accordingly, when there is an attempt to send an SMS message, from one network subscriber's telephone to an intended recipient subscriber's telephone, the message can is stored by a telecommunications carrier of the telecommunications network, when the intended recipient subscriber cannot be reached. At a later time when the recipient subscriber can be reached, the short message is then automatically transmitted to this subscriber.

Using SMS messaging, it is possible able to exchange alphanumeric messages of up to 160 characters per message. Although SMS was originally created as a paging mechanism for notifying users of the arrival of voicemail, it is now used primarily as a messaging service for radio telephones. However, basic SMS message protocols provide for the sending of only alphanumeric text without any multimedia data attachments such as music, photographs, icons, animations, videos and the like. Accordingly, to facilitate the inclusion of multimedia attachments to short messaging protocols, Enhanced Message Service (EMS) short messages and Multimedia Messaging Service (MMS) messages have been developed.

When attempting to attach a multimedia file to a MMS message, a user may often have to search through libraries or databases of possible multimedia files in order to select a suitable file for attachment. The efficiency of such a search in a database depends upon the quality of the metadata associated with the multimedia files in the database. The metadata typically describes the content of a multimedia file. In general, metadata describing file content is of suitable quality if it is relevant to the file content and describes the file uniquely when compared to other metadata in the database.

Even if the metadata is of a suitable quality, a user must know what metadata to select when searching for multimedia to attach to an MMS file. Thus, the metadata selection, file searching and possible repeated iterative metadata re-selection and file searching for files appropriate to the MMS message content may be tiresome, time consuming and unacceptable.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a method for identifying, from a plurality of files, at least one file suitable for attaching to a text message to be transmitted from an electronic device, the method being effected by the device and the method comprising:
identifying at least one keyword or phrase in the message to be used in a metadata search;
searching a least one database for files identified by metadata corresponding to at least one search word associated with the keyword or phrase; and
identifying the least one file suitable for attaching to the message, the at least one file having associated metadata matching the search word.

Suitably, the identifying includes selecting nouns as the keyword. Preferably, the identifying includes selecting verbs as the keyword.

The search word may preferably include synonyms thereof. The search word may also be plural and singular. Suitably, the verbs, if required, are put into their simple present tense. Preferably, the search word exactly matches the metadata.

Preferably, the search word partially matches the metadata. Word stemming for the search word may be suitably used during the identifying the least one file.

Suitably, the identifying the at least one file includes listing metadata associated therewith and metadata of other potentially suitable files.

Preferably, the method also provides for selecting and attaching the at least one file to the message.

Suitably, the method allows for transmitting the message with the at least one file attached thereto.

According to another aspect of the invention, there is provide an electronic device comprising:
a communications unit;
a keypad; and
   a processor operatively coupled to both the keypad and communications unit, wherein in use the processor performs:
      identifying at least one keyword or phrase in the message to be used in a metadata search;
      searching a least one database for files identified by metadata corresponding to at least one search word associated with the keyword or phrase; and
      identifying the least one file suitable for attaching to the message, the at least one file having associated metadata matching the search word.

Suitably, the device has a display screen for listing metadata associated with the least one file suitable.

Preferably, the device provides for transmitting the message with the at least one file attached thereto, the transmitting being effected by the communications unit.

Suitably, the communications unit is a radio communications unit.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a block diagram illustrating an embodiment of a radio telephone in accordance with the invention; and

FIG. 2 is a flow diagram illustrating a method for identifying, from a plurality of files, at least one file suitable for attaching to a text message to be transmitted from the radio telephone of FIG. 1.

### DETAILED DESCRIPTION OF THE PREFERRED EMBODIMENT OF THE INVENTION

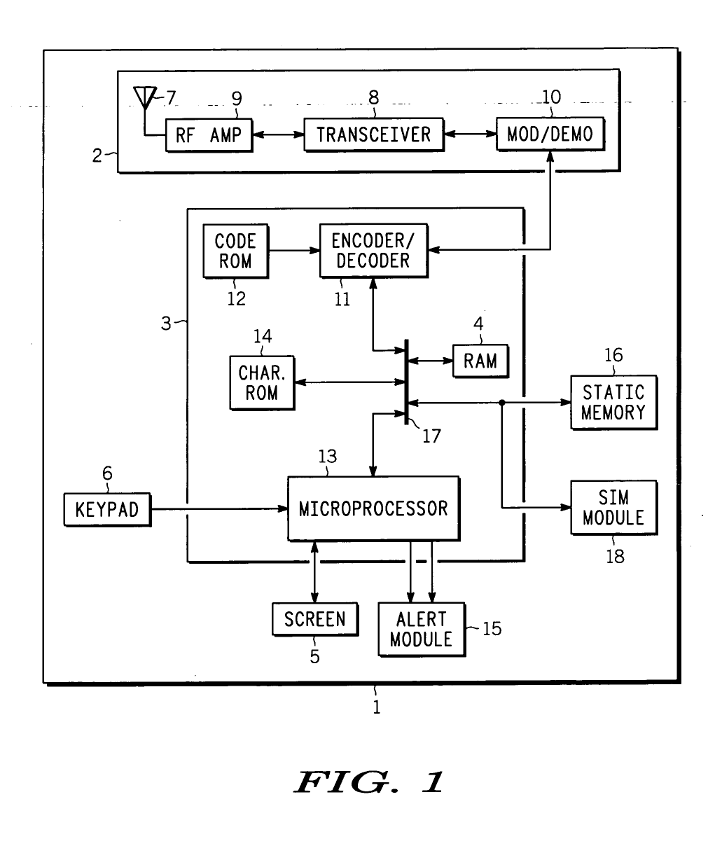

In the drawings, like numerals on different Figs are used to indicate like elements throughout. With reference to FIG. 1, there is illustrated an electronic device in the form of a radio telephone 1 comprising a radio frequency communications unit 2 coupled to be in communication with a processor 3. An input interface in the form of a screen 5 and a keypad 6 are also coupled to be in communication with the processor 3.

The processor 3 includes an encoder/decoder 11 with an associated Read Only Memory (ROM) 12 storing data for encoding and decoding voice or other signals that may be transmitted or received by the radio telephone 1. The processor 3 also includes a micro-processor 13 coupled, by a common data and address bus 17, to an encoder/decoder 11 and an associated character Read Only Memory (ROM) 14, a Random Access Memory (RAM) 4, static programmable memory 16 and a removable SIM module 18. The static programmable memory 16 and SIM module 18 each can store, amongst other things, selected incoming text messages and Search String Library SSL (described below).

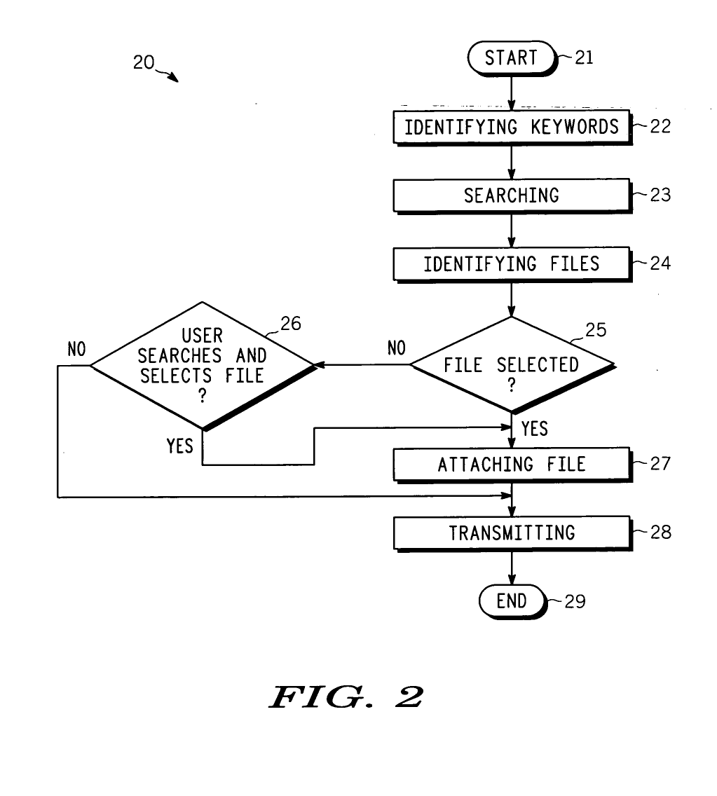

The micro-processor 13 has ports for coupling to the keypad 6, the screen 5 and an alert module 15 that typically contains a speaker, vibrator motor and associated drivers. The character Read only memory 14 stores code for decoding or encoding text messages that may be received by the communication unit 2, input at the keypad 6. In this embodiment the character Read Only Memory 14 also stores operating code (OC) for micro-processor 13 and code for performing a method as described below with reference to FIG. 2.

The radio frequency communications unit 2 is a combined receiver and transmitter having a common antenna 7. The communications unit 2 has a transceiver 8 coupled to antenna 7 via a radio frequency amplifier 9. The transceiver 8 is also coupled to a combined modulator/demodulator 10 that couples the communications unit 2 to the processor 3.

Referring to FIG. 2 there is illustrated a method 20 for identifying, from a plurality of files, at least one file suitable for attaching to a text message to be transmitted from the electronic device in the form of the radio telephone 1. The method 20 starts at a start step 21, after or during creation of the text message that is input typically by the keypad 6. As will be apparent to a person skilled in the art, the text message is typically an EMS or MMS message however the invention is not limited to these messaging systems or radio telephone text messages.

The method 20 then proceeds to an identifying keywords step 22 where the processor 3 performs Identifying at least one keyword or phrase in the message to be used in a metadata search. The identifying keywords step 22 includes selecting nouns and verbs as keywords, where the processor compares words and phrases in the Search String Library SSL of static memory 16. The Search String Library SSL is a database of keywords and phrases including the following strings:

“love”, “heart”, “hungry” “picture”, “time”, “drink”, “run” “meet”, “music”, “happy”, “sad”, “disappointed”, “call me”, “pop group”, “not well”, “very happy”, “very sad” etc.

The method 20 then effects a searching step 23 where the processor 3 performs searching a database, or databases, for files identified by metadata corresponding to a search word (or search words) associated with the keyword or phrase. These databases can be stored in the static memory 16 (or local accessible memory) or on a network accessible through the radio frequency communications unit 2 The processor 3 then effects an identifying files step 24 where the method 20 provides for identifying the least one file, in the databases, suitable for attaching to the message, the at least one file having associated metadata matching the search word.

Each of the search words may preferably include synonyms thereof. For instance, if the search word is “worship” then “adore” will also be used as a search word. The search word may also be plural and singular so that “love” and “loves” are searched. Suitably, the verbs, if required, are put into their simple present tense. For example, the search word “worked” is put into the simple s present tense of the verb “work”. In other words, the identifying files step 24 uses word stemming for the search word to identify metadata associated with potentially suitable files for attaching to the text message. Word stemming is described in “W. B. Frakes and R. Baeza-Yates, editors, Information Retrieval: Data Structures and Algorithms, chapter 8, pages 131-160. Prentice-Hall, Englewood Cliffs, USA, 1992” and is incorporated into this specification by reference.

During the identifying step 24, preferably, the search word exactly matches the metadata however the search word partially matches the metadata. Also, the identifying step 24 includes listing metadata associated with an identified file and metadata of other potentially suitable files. This listing is typically displayed on the display screen 5 in a ranked list based on user preferences, based for instance on user history, as is well known in the art.

After the identifying step 24 a file selected test 25 is conducted to check if a user wishes to select one or more of the identified files. If the user inputs a command, at keypad 6, declining selection of the identified files, a test 26 determines if the user wishes to search and select any files for attachment by appropriate selection of key on the keypad 6. If the method 20 determines that the user has selected a file, at test steps 25 or 26, then an attaching file step 27 attaches selected files to the message. A transmitting step 28 then transmits the message with the file or files attached thereto by radio transmission through the radio communications unit 2. However, if at test step 26 file selection is declined, the message is transmitted at the transmitting step 28 without any attachments. The method then terminates at an end step 29.

Advantageously, the present invention provides for automatic identifying possible files that may be suitable for inclusion or attaching to, for instance, an EMS or MMS text message. Accordingly, the invention alleviates potentially tiresome and time consuming manual metadata selection, file searching and possible repeated iterative metadata re-selection and file searching for files appropriate to attach to EMS or MMS message content.

The detailed description provides a preferred exemplary embodiment only, and is not intended to limit the scope, applicability, or configuration of the invention. Rather, the detailed description of the preferred exemplary embodiment provides those skilled in the art with an enabling description for implementing preferred exemplary embodiment of the invention. It should be understood that various changes may be made in the function and arrangement of elements without departing from the spirit and scope of the invention as set forth in the appended claims.

1. A method for identifying, from a plurality of files, at least one file suitable for attaching to a text message to be transmitted from an electronic device, the method being effected by the device and the method comprising:
identifying at least one keyword or phrase in the message to be used in a metadata search;
searching a least one database for files identified by metadata corresponding to at least one search word associated with the keyword or phrase; and
identifying the least one file suitable for attaching to the message, the at least one file having associated metadata matching the search word.

2. A method, as claimed in claim 1, wherein the identifying includes selecting nouns as the keyword.

3. A method, as claimed in claim 1, wherein the identifying includes selecting verbs as the keyword.

4. A method, as claimed in claim 1, wherein the search word includes synonyms thereof.

5. A method, as claimed in claim 1, wherein the search word exactly matches the metadata.

6. A method, as claimed in claim 1, wherein the search word partially matches the metadata.

7. A method, as claimed in claim 1, wherein word stemming for the search word is used during the identifying the least one file.

8. A method, as claimed in claim 1, wherein the identifying the at least one file includes listing metadata associated therewith and metadata of other potentially suitable files.

9. A method, as claimed in claim 1, wherein the method also provides for selecting and attaching the at least one file to the message.

10. A method, as claimed in claim 1, wherein the method allows for transmitting the message with the at least one file attached thereto.

11. An electronic device comprising:
a communications unit;
a keypad; and
a processor operatively coupled to both the keypad and communications unit, wherein in use the processor performs:
identifying at least one keyword or phrase in the message to be used in a metadata search;
searching a least one database for files identified by metadata corresponding to at least one search word associated with the keyword or phrase; and
identifying the least one file suitable for attaching to the message, the at least one file having associated metadata matching the search word.

12. An electronic device, as claimed in claim 11, further including a display screen for listing metadata associated with the least one file suitable.

13. An electronic device, as claimed in claim 11, wherein the device provides for transmitting the message with the at least one file attached thereto, the transmitting being effected by the communications unit.

14. An electronic device, as claimed in claim 11, wherein the communications unit is a radio communications unit.
